(19) United States
(12) Patent Application Publication
(10) Pub. No.: US 2005/0248793 A1
(43) Pub. Date: Nov. 10, 2005

(54) System and method for dynamically adjusting printing processes

(76) Inventors: Fu-Chang Lin, Taipei (TW); Wen-Jie Chien, Taipei (TW)

Correspondence Address: BIRCH STEWART KOLASCH & BIRCH, PO BOX 747, FALLS CHURCH, VA, 22040-0747, US

(21) Appl. No.: 10/838,254

(22) Filed: May 5, 2004

(51) Int. Cl. G06F 15/00; G06F 15/02

(52) U.S. Cl. 358/1.13; 358/1.16

(57) ABSTRACT

A system for dynamically adjusting printing processes along with the method thereof is disclosed. The system contains an image data conversion module for converting image data to printing data, a printing data buffer for storing the printing data, and a data transmission module for detecting the operation status of the printing device and transmitting the printing data. In particular, image data conversion is performed when the memory of the printing device is full. When the memory of the printing device is empty, the printing data is read from the printing data buffer and sent to the printing device. Therefore, the operation resources of the data processing device can be fully utilized for continuous printing.

### BACKGROUND OF THE INVENTION

1. Field of Invention

The invention relates to a system and a method for printing processes and, in particular, to a system and a method for dynamically adjusting the printing processes according to the operation status of the printing device.

2. Related Art

With the advances in information technology, the computer devices have more powerful functions. As their prices get lower, it is no longer hard for people to own set computer equipment. In particular, the appearance of printing devices such as the copiers, printers, and multi-function peripherals (MFP) has a great impact in daily life and office works because of their scanning and printing functions that enable the preparation and duplication of documents.

There are many designs about printing devices. Some technologies have been disclosed and well known to the general public. For example, the U.S. Pat. Nos. 3,990,559 and 5,927,871 provide related techniques. The former case discloses a device that controls the printing speed and the method thereof. They are used in matrix printers. It primarily contains a progressively accelerating print head so that the printer can perform continuous printing processes. The latter case discloses a printer with buffer memory. It mainly contains a scanning unit for scanning images, a memory unit for storing printing data, a writing unit for writing the printing data into the memory unit, and a reading unit for simultaneously scanning and reading the printing data. The memory unit has continuous memory addresses for the corresponding printing data in order to increase the printing speed of the printer.

Although the above-mentioned prior art can perform reasonable jobs and have certain effects, the improvements are mostly in the printing device but the printing procedure. In the normal printing procedure, a utility program in the computer sends image data to the printer driver and the background module. The image data are converted to produce printing data. The printing data are further transmitted to a printing device such as printer to print. However, as there is a higher demand for a better printing quality, the memory inside the printing device is often not enough to store the huge printing data. The computer has to wait until some of the memory of the printer is released before sending the next set of printing data. When a printing device prints a document following the conventional printing procedure, the process of converting image data is forced to pause and wait. Therefore, the operation efficiency of the computer equipment cannot be optimized. In other words, the printing procedure is usually slowed down by the printing process or the image data conversion process. Generally speaking, if the system is busy in either of the above-mentioned processes, the printing procedure has to wait until it is finished. This is the main reason why the conventional printing process is not continuous. SUMMARY OF THE INVENTION

In view of the foregoing, the invention discloses a system for dynamically adjusting printing processes along the method thereof. A primary objective of the invention is to make efficient use of the whole operating system (OS) in order to increase the probability of perform a continuous printing process.

The disclosed system for dynamically adjusting printing processes includes an image data conversion module, a printing data buffer unit, and a data transmission module. The image data conversion module converts the image data provided by a background module of a data processing device into printing data. The printing data buffer unit stores the printing data for building a printing queue. The data transmission module has a detection processing unit and a transmission module. The detection processing unit detects the operation status of the printing device. The transmission unit sends the printing data to the printing device.

The invention further discloses a method for dynamically adjusting printing processes. According to the method, the system first reads the image data provided by the background module of the data processing device. The system then converts the image data to generate printing data. The printing data are stored in the printing data buffer unit for establishing a printing queue. Finally, the system detects the operation status of the printing device. When the memory of the printing device is fully loaded, the procedure goes back to the above-mentioned steps, reading the image data and performing conversions. On the other hand, if the memory of the printing device is released, the printing data are sent to the printing device.

The invention can effectively solve the traffic jams occurring in the conventional printing process, and has at least the following advantages:

(1) It fully utilizes system resources. In the printing procedure of the prior art, the image data conversion process and the data transmission process are the bottleneck of the whole process. The central processing unit (CPU) of the data processing device stays in the operation status in these cases. Therefore, the efficiency of the system cannot be increased and the resources cannot be shared by other programs. According to the invention, when the memory of the printing device is fully loaded, the system keeps performing image data reading and conversion processes instead of waiting until the printing device releases its memory as in the prior art. Once the memory of the printing device is released, the printing data are obtained from the printing data buffer unit. Thus, the usage of system resources can be optimized.

(2) It provides the function of continuous printing. As described above, the system does not read and convert the image data until the printing device releases its memory according to the printing procedure in the prior art. This inevitably elongates the printing time because of waiting. The invention enables the printing device to extract required printing data once its memory is released. Thus, the printing device can perform continuous printing, without waiting for the data conversion and transmission.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of the disclosed system for dynamically adjusting printing processes;

FIG. 2A is a flowchart of the disclosed method for dynamically adjusting printing processes; and

FIG. 2B is a continued flowchart of the disclosed method for dynamically adjusting printing processes.

### DETAILED DESCRIPTION OF THE INVENTION

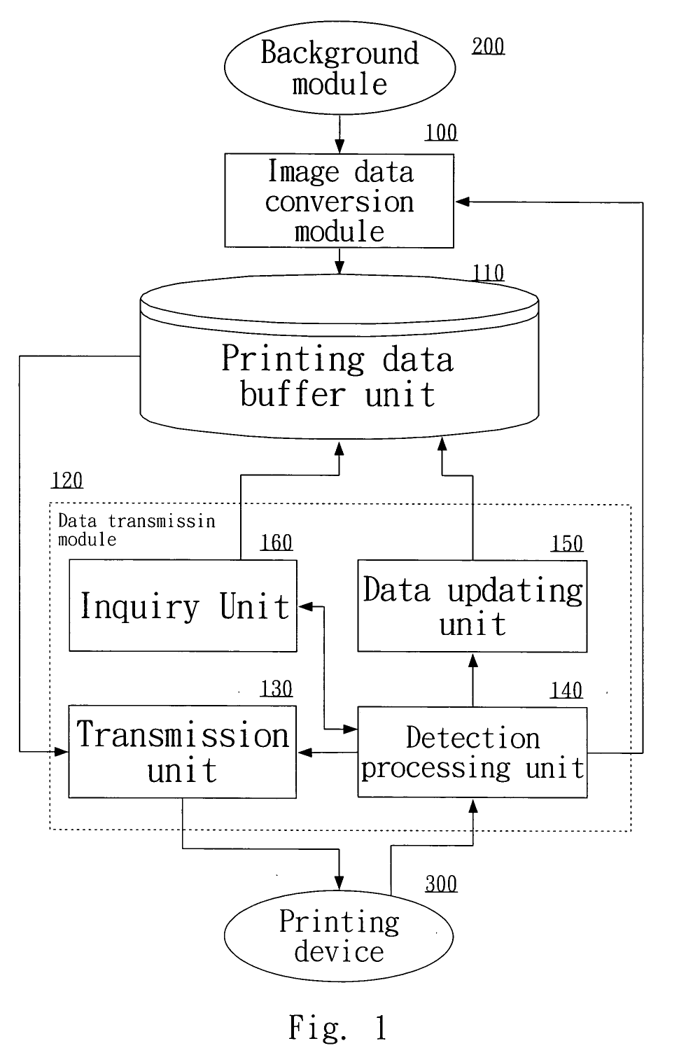

When applying the disclosed system for dynamically adjusting printing processes to a data processing device, the printing procedure is, through the functioning of the data processing end, dynamically adjusted according to the status of the printing device. As shown in FIG. 1, the system contains:

(1) Image data conversion module 100: It is in the data processing device to convert the image data transmitted from a utility via a printer driver to a background module 200 into printing data.

(2) Printing data buffer unit 110: It is used to store the printing data and to establish a printing queue thereby.

(3) Data transmission module 120: It contains a transmission unit 130, a detection processing unit 140, a data updating unit 150, and an inquiry unit 160. The transmission unit 130 reads the printing data from the printing data buffer unit 110 and transfers them to the printing device 300 for printing. The detection processing unit 140 detects the operation status of the printing device 300. When the memory of the printing device 300 is fully loaded, the detection processing unit 140 notifies the image data conversion unit 100 to read and convert image data and to generate more print data without waiting the printing device 300 to finish its printing process. Once the memory of the printing device 300 is released because the printing process is completed, the transmission unit 130 sends the printing data. Afterwards, the data updating unit 150 is controlled by the detection processing unit 140 to update the printing queue. After the transmission unit 130 sends a set of printing data to the printing device 300, the printing device 300 notifies the detection processing unit 140. The detection processing unit 140 controls the inquiry unit 160 to perform the comparison and inquiry processes of the printing queue, checking whether the printing data buffer unit 110 still has any printing data.

(4) Printing device 300. It is used to receive the printing data transmitted from the transmission unit 130 and to perform the printing process.

According to the above-described composition, the data processing device is processing in the data processing device and does not need to wait for the printing device 300 to complete the current printing job in order to carry out the next image data conversion. As a consequence, the invention can fully utilize the resources of the data processing device.

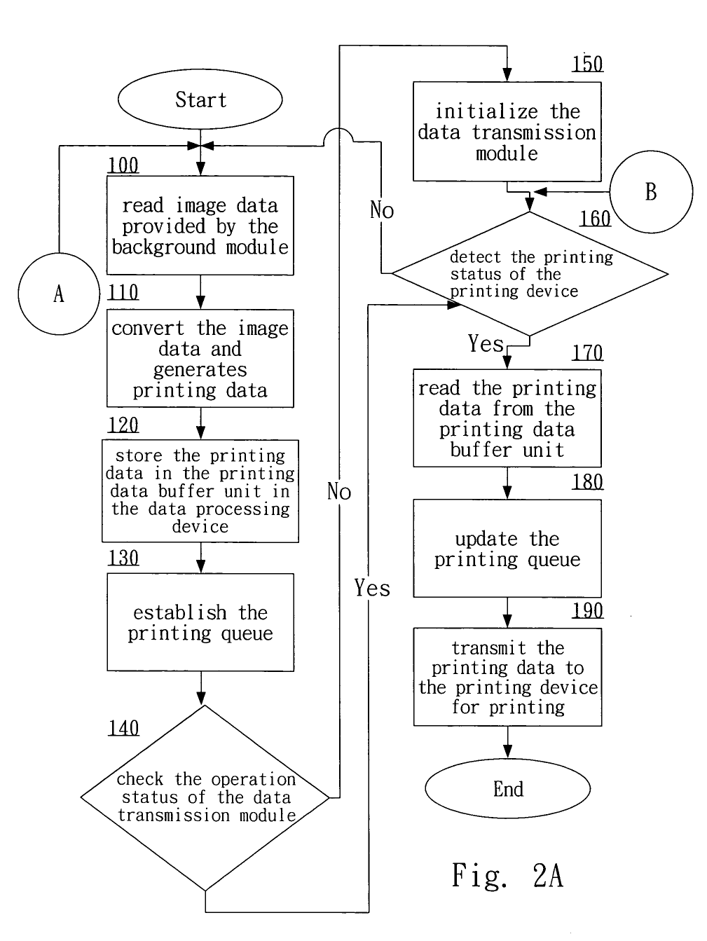

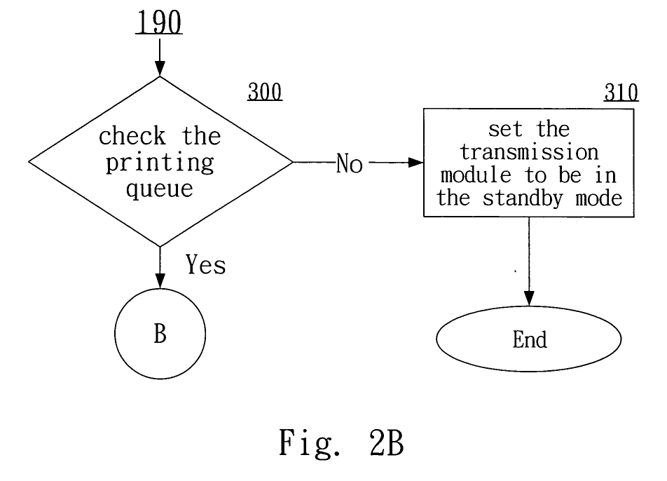

Along with the disclosed system, the invention further provides a method for dynamically adjusting printing processes implemented on the above-mentioned system. The method improves the printing procedure at the data processing device in order to achieve a better performance and the possibility of continuous printing. We refer to FIGS. 2A and 2B for a detailed description of the steps.

In the beginning, the system reads image data provided by the background module of the data processing device (step 100). Afterwards, the system converts the image data and generates printing data (step 110). The printing data are then stored in the printing data buffer unit in the data processing device (step 120). A printing queue is established according to the printing data (step 130). The system checks the operation status of the data transmission module (step 140). If the data transmission module is not active, the system initializes the data transmission module (step 150). Otherwise, the system directly detects the printing status of the printing device (step 160). If the memory of the printing device is full, the system returns to step 100 for converting and transmitting another set of image data without waiting for the printing device to release the memory. On the other hand, if the memory of the printing device is released after completing the printing process, the system reads in the printing data from the printing data buffer unit (step 170) and updates the printing queue (step 180). Afterwards, the system transmits the printing data to the printing device for printing (step 190).

In fact, the system further checks the printing queue (step 300) after step 190. If there are other printing data in the printing queue, the procedure returns to step 160 for the next printing job. Otherwise, it means that there is no further printing data to process. The system then sets the transmission module to be in the standby mode (step 310).

The disclosed system and method for dynamically adjusting printing processes avoid the delay caused by waiting the printing device to finish the current printing job as in the prior art. The invention dynamically adjusts the printing procedure according to the printing status of the printing device. When the memory of the printing device is full, the system is notified to convert and transmit another set of image data. After the memory of the printing device is released, the system can read in the printing data at any time from the printing data buffer unit and send them over to the printing device for printing. The invention thus achieves the goals of efficiently using the resources of the data processing device and of continuous printing.

Certain variations would be apparent to those skilled in the art, which variations are considered within the spirit and scope of the claimed invention.

1. A system for dynamically adjusting printing processes in a data processing device, comprising:
an image data conversion module, which converts image data provided by a background module of the data processing device into printing data;
a printing data buffer unit, which stores the printing data and establishes a printing queue accordingly; and
a data transmission module, which includes a detection processing unit and a transmission unit, the detection processing unit detecting the operation status of a printing device so that the transmission unit reads the printing data in the printing data buffer unit and sends the printing data to the printing device for printing when the memory of the printing device is released.

2. The system of claim 1, wherein the data transmission module further contains a data updating unit to update the printing queue according to the printing processes performed by the printing device.

3. The system of claim 1, wherein the data transmission module further contains an inquiry unit to check the printing queue for determining when to transmit the printing data using the transmission unit.

4. The system of claim 1, wherein the detection processing unit notifies the image data conversion module to read and convert another set of image data, generating another set of printing data, when the memory of the printing device is full.

5. A method for dynamically adjusting printing processes, comprising the steps of:
a. reading image data provided by a background module of a data processing device;
b. converting the image data to generate printing data;
c. storing the printing data in a printing data buffer unit of the data processing device; and
d. detecting the operation status of a printing device and returning to step a if the memory of the printing device is full and sending the printing data to the printing device when the memory of the printing device is released.

6. The method of claim 5, wherein step c further comprises the steps of:
checking the operation status of a data transmission module; and
initializing the data transmission module.

7. The method of claim 5, wherein step b contains the step of establishing a printing queue according to the printing data.

8. The method of claim 7, wherein the step of sending the printing data to the printing device when the memory of the printing device is released further contains the step of updating the printing queue.

9. The method of claim 7, wherein the step of sending the printing data to the printing device when the memory of the printing device is released further contains the step of checking the printing queue.

10. The method of claim 9, wherein the step of checking the printing queue includes the step of setting the data transmission module in the standby mode.
